(19) United States
(12) Patent Application Publication
(10) Pub. No.: US 2011/0080834 A1
(43) Pub. Date: Apr. 7, 2011

(54) COMMUNICATION APPARATUS AND COMMUNICATION CONTROL METHOD

(75) Inventors: Masaki Hirota, Kawasaki (JP); Jun Tanaka, Kawasaki (JP)

(73) Assignee: FUJITSU LIMITED, Kawasaki-shi (JP)

(21) Appl. No.: 12/896,567

(22) Filed: Oct. 1, 2010

(30) Foreign Application Priority Data
Oct. 2, 2009 (JP) 2009-230083

(51) Int. Cl. H04L 12/26

(52) U.S. Cl. 370/236

(57) ABSTRACT

A communication apparatus that sends and receives signals, the communication apparatus includes a pause signal transmitter that transmits a pause signal to a plurality of linked apparatus that send data to the communication apparatus, wherein the pause signal requests that the transmission of data to the communication apparatus be temporarily paused, and a transmission controller that uses guaranteed rates prescribed for respective linked apparatus as a basis for separately controlling how the pause signal is transmitted to respective linked apparatus receiving the signal, wherein the transmission controller controls how the pause signal is transmitted such that the data transfer rates from respective linked apparatus to the communication apparatus become rates equal to or greater than the guaranteed rates corresponding to the respective linked apparatus.

### CROSS-REFERENCE TO RELATED APPLICATIONS

This application is based upon and claims the benefit of priority of the prior Japanese Patent Application No. 2009-230083, filed on Oct. 2, 2009, the entire contents of which are incorporated herein by reference.

### FIELD

The embodiments discussed herein are related to a communication apparatus that sends and receives signals, as well as to a communication control method for such a communication apparatus.

### BACKGROUND

Ethernet (registered trademark) is the most typical local network (LAN) protocol, and has been standardized by the Institute of Electrical and Electronic Engineers (IEEE) 802.3, for example. In Ethernet, a PAUSE frame is defined as a frame for flow control. By transmitting this PAUSE frame to the apparatus sending data, a request can be issued to stop data transmission for a fixed period.

FIG. 16 summarizes a flow control that uses a PAUSE frame. The communication node N1 illustrated in FIG. 16 includes interfaces (I/Fs) 810, 820, and 830, a switch (S/W) 840, and a controller 850. The interfaces 810, 820, and 830 send and receive data with respect to other communication nodes via Ethernet. In the example illustrated in FIG. 16, the interface 820 is connected to a communication node N2, while the interface 830 is connected to a communication node N3. In addition, the interface 810 is taken to be connected to another communication node not illustrated. In FIG. 16, the maximum transfer rate between communication nodes is taken to be 1 Gbps. The switch 840 switches the respective connections among the interfaces 810, 820, and 830. The controller 850 primarily switches the connecting behavior of the switch 840 according to the destination of received data.

At this point, consider the combined transfer rate made up of the transfer rate of transmitted data from the communication node N2 to the communication node N1, as well as the transfer rate of transmitted data from the communication node N3 to the communication node N1. If this combined transfer rate were to exceed 1 Gbps, for example, then congestion will occur at the communication node N1. Upon detecting congestion, the communication node N1 transmits PAUSE frames to the communication nodes N2 and N3.

In a PAUSE frame, there is defined a field for storing the pause time during which data transmission is paused. Upon receiving a PAUSE frame, the communication nodes N2 and N3 pause the transmission of data to the communication node N1 until the pause time stored in the PAUSE frame has elapsed. In so doing, traffic from the communication nodes N2 and N3 to the communication node N1 is restricted.

Meanwhile, in communication nodes, congestion is often detected on the basis of the size of data in an internal buffer. For example, in the communication node N1 in FIG. 16, the controller 850 monitors the size of data in an output buffer 811 provided in the interface 810. The controller 850 then determines that congestion exists when the size of data in the output buffer 811 equals or exceeds a predetermined threshold value.

Methods for transmitting PAUSE frames on the basis of the size of data in an internal buffer typically belong to one of the following two categories. FIG. 17 illustrates one example of a flow control sequence based on the size of data in an output buffer.

For example, the communication node N1 may monitor the output buffer 811 to determine whether or not the size of data therein equals or exceeds a threshold value Th1. When the size of data in the output buffer 811 becomes equal to or greater than the threshold value Th1, the communication node N1 outputs a PAUSE frame with respect to the one or more communication nodes from which data transmission originates. For example, if X (in bits per second) is taken to be the upper limit on the data transfer rate from the output buffer 811 to the destination node, and if Y (in bits) is taken to be the size of data stored in the output buffer 811, then the communication node N1 may set the pause time stored in the PAUSE frame to a value not more than Y/X (seconds). In addition, once Y/X (seconds) has elapsed after transmitting a single such PAUSE frame, the communication node N1 may transmit a PAUSE frame again if the size of data in the output buffer 811 equals or exceeds the threshold value Th1. Alternatively, the communication node N1 may terminate transmission of the PAUSE frame if the size of data in the output buffer 811 is less than the threshold value Th1.

FIG. 18 illustrates another example of a flow control sequence based on the size of data in an output buffer. In the example in FIG. 18, the determination of the size of data in the output buffer 811 is conducted on the basis of the two threshold values Th1 and Th2 (where Th1>Th2). When the size of data in the output buffer 811 becomes equal to or greater than the threshold value Th1, the communication node N1 outputs a PAUSE frame with respect to the one or more communication nodes from which data transmission originates. At this point, the maximum prescribed value for the pause time is stored in the PAUSE frame. Once the maximum pause time has elapsed after transmitting a single such PAUSE frame, the communication node N1 transmits a PAUSE frame again if the size of data in the output buffer 811 equals or exceeds the threshold value Th2. In contrast, if the size of data is less than the threshold value Th2, then the communication node N1 outputs a PAUSE frame to each communication node from which data transmission originates, with each PAUSE frame storing the minimum prescribed value (ordinarily 0) for the pause time. A communication node receiving a PAUSE frame storing the minimum value for the pause time will then start sending data to the communication node N1.

Meanwhile, switches, routers, and other communication apparatus used for services such as virtual private networks (VPNs) are sometimes provided with functions for guaranteeing a particular transfer rate. Hereinafter, such a guaranteed transfer rate will be referred to as the guaranteed rate. When congestion occurs at a given communication node on a network that includes such communication apparatus, a flow control is conducted by transmitting a PAUSE frame from the congested communication node to the one or more nodes from which data transmission originates. At this point, since the congested communication node conducts a flow control according to the size of data in its internal buffer as described above, there is a possibility that the transfer rate of a sender node will fall below the guaranteed rate.

FIG. 19 illustrates an example of operation in the case where the transfer rates of sender nodes fall below the guaranteed rates. In the example in FIG. 19, a guaranteed rate of 500 Mbps is prescribed for the communication node N2, while a guaranteed rate of 250 Mbps is prescribed for the communication node N3. Herein, it is assumed that the communication node N2 sends data to the communication node N1 at a real transfer rate exceeding the guaranteed rate, while the communication node N3 also sends data to the communication node N1 at a real transfer rate exceeding the guaranteed rate. For example, the real transfer rate from the communication node N2 to the communication node N1 may be 800 Mbps, while the real transfer rate from the communication node N3 to the communication node N1 may be 400 Mbps. As a result, the combined transfer rate with respect to the communication node N1 exceeds the upper limit of 1 Gbps for the transfer rate from the interface 810, and thus congestion occurs at the communication node N1.

As described earlier, the controller 850 in the communication node N1 determines that congestion has occurred when the size of data in the output buffer 811 substantially equals or exceeds a predetermined threshold value. On the basis of this determination, the communication node N1 transmits a PAUSE frame to the communication nodes N2 and N3, and temporarily pauses data transmission. In other words, the communication node N1 conducts a flow control irrespectively of the guaranteed rates for the communication nodes N2 and N3. For this reason, there is a possibility that the transfer rates of data from the communication nodes N2 and N3 might fall below their guaranteed rates.

There exist various apparatus that conduct flow controls using a PAUSE frame. For example, a switching hub may transmit a PAUSE packet to an input port exceeding its allocated bandwidth when congestion occurs at the output ports. As another example, a sending apparatus may transmit a PAUSE packet to a linked upstream apparatus when the amount of incoming packets exceeds a first threshold value, and may also pause its own transmission of packets when the amount of incoming packets further exceeds a second threshold value. As another example, a quality of service (QoS) management server may transmit PAUSE frames to a plurality of client apparatus to regulate data rates to the client apparatus according to priority information.

### SUMMARY

According to an aspect of the embodiment, a communication apparatus that sends and receives signals, the communication apparatus includes a pause signal transmitter that transmits a pause signal to a plurality of linked apparatus that send data to the communication apparatus, wherein the pause signal requests that the transmission of data to the communication apparatus be temporarily paused, and a transmission controller that uses guaranteed rates prescribed for respective linked apparatus as a basis for separately controlling how the pause signal is transmitted to respective linked apparatus receiving the signal, wherein the transmission controller controls how the pause signal is transmitted such that the data transfer rates from respective linked apparatus to the communication apparatus become rates equal to or greater than the guaranteed rates corresponding to the respective linked apparatus.

The object and advantages of the embodiment will be realized and attained by at least the features, elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 illustrates the configuration of a communication system in accordance with a first embodiment;

FIG. 2 illustrates the configuration of a communication system in accordance with a second embodiment;

FIG. 3 illustrates the internal configuration of a communication apparatus in further detail;

FIG. 4 illustrates the content of a PAUSE frame;

FIG. 5 is a diagram for explaining a flow control executed in the second embodiment;

FIG. 6 is a flowchart illustrating a PAUSE frame output processing sequence;

FIG. 7 is a flowchart illustrating another example of a PAUSE frame output processing sequence;

FIG. 8 is a diagram for explaining a flow control executed in a third embodiment;

FIG. 9 is a diagram for explaining a flow control executed in a fourth embodiment;

FIG. 10 illustrates the internal configuration of a communication apparatus in accordance with a fifth embodiment;

FIG. 11 is a flowchart illustrating a processing sequence for calculating the pause time and the pause interval;

FIG. 12 is a diagram for explaining an example of a flow control executed in the fifth embodiment;

FIG. 13 illustrates the content of an LLDP frame;

FIG. 14 is a diagram for explaining an LLDP frame delivery process;

FIG. 15 illustrates the internal configuration of a communication apparatus in accordance with a sixth embodiment;

FIG. 16 summarizes a flow control that uses a PAUSE frame;

FIG. 17 is a diagram for explaining one example of a flow control sequence based on the size of data in an output buffer;

FIG. 18 is a diagram for explaining another example of a flow control sequence based on the size of data in an output buffer; and

FIG. 19 illustrates an example of operation in the case where the transfer rates of sender nodes fall below the guaranteed rates.

### DESCRIPTION OF EMBODIMENTS

In the figures, dimensions and/or proportions may be exaggerated for clarity of illustration. It will also be understood that when an element is referred to as being “connected to” another element, it may be directly connected or indirectly connected, i.e., intervening elements may also be present. Further, it will be understood that when an element is referred to as being “between” two elements, it may be the only element between the two elements, or one or more intervening elements may also be present.

As described earlier, when executing a flow control, there is a problem in that the data transfer rate from upstream communication nodes sending data might fall below the guaranteed rates prescribed for those communication nodes.

In light of such issues, embodiments of the present invention at least provides a communication apparatus and a communication control method whereby the data transfer rates from the flow-controlled communication nodes are prevented from falling excessively.

In order to achieve the above object, there is provided a communication apparatus that sends and receives signals. The communication apparatus includes a pause signal transmitter and a transmission controller. The pause transmitter transmits a pause signal to a plurality of linked apparatus that send data to the communication apparatus. The pause signal requests that the transmission of data to the communication apparatus be temporarily paused. On the basis of guaranteed rates prescribed for each linked apparatus, the transmission controller separately controls how the pause signal is transmitted to each linked apparatus receiving the signal. The transmission controller controls how the pause signal is transmitted such that the data transfer rate from each linked apparatus to the communication apparatus becomes a rate substantially equal to or above the guaranteed rate for each linked apparatus.

In addition, in order to achieve the above object, there is provided a communication control method for conducting a process similar to that of the above communication apparatus.

According to the above communication apparatus and communication control method, data transfer rates from linked apparatus are prevented from falling excessively.

Hereinafter, embodiments will be described in detail and with reference to the accompanying drawings.

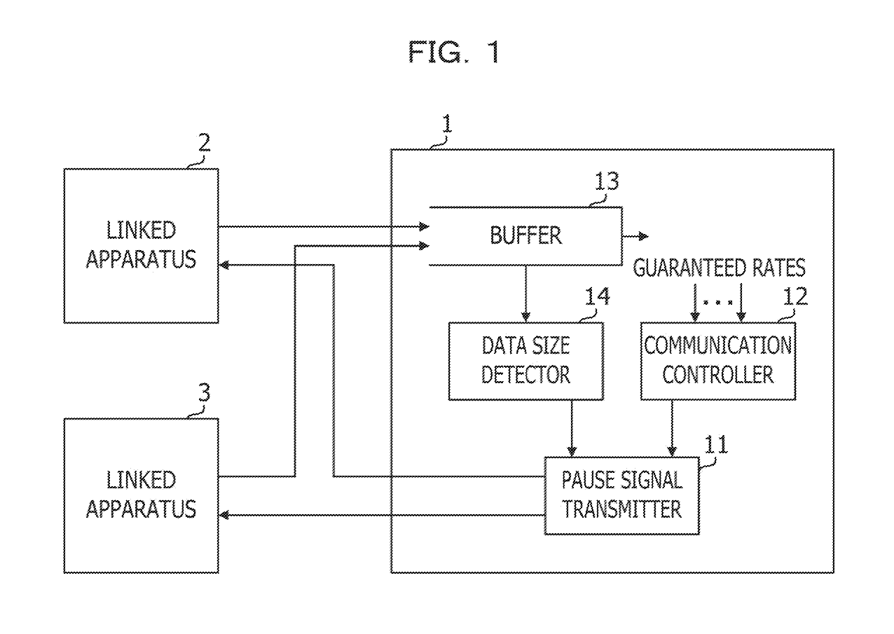

FIG. 1 illustrates the configuration of a communication system in accordance with a first embodiment.

The communication apparatus 1 sends and receives signals with respect to a plurality of linked apparatus. In FIG. 1, two linked apparatus 2 and 3 are illustrated by way of example. In addition, the communication apparatus 1 includes a function for conducting flow control by transmitting a pause signal to the plurality of linked apparatus. The pause signal is a signal requesting recipient apparatus to pause the transmission of data. A linked apparatus that receives the pause signal will pause data transmission operations to the communication apparatus 1 for a set amount of time, on the basis of the pause signal. For example, the pause signal may include pause duration information, which indicates the period during which recipient apparatus are made to pause data transmission. In this case, a linked apparatus that receives the pause signal will pause data transmission operations to the communication apparatus 1 for the period of time indicated by the pause duration information included in the pause signal.

The communication apparatus 1 includes a pause signal transmitter 11 and a communication controller 12. The pause signal transmitter 11 transmits the pause signal described above to the one or more linked apparatus sending data to the communication apparatus 1. Herein, the pause signal is individually transmitted to each recipient apparatus. The communication controller 12 separately controls how the pause signal is transmitted by the pause signal transmitter 11 for each linked apparatus receiving the signal.

At this point, a process executed by the communication controller 12 will be described for the case when data has been sent to the communication apparatus 1 from the linked apparatus 2 and 3. However, it should be appreciated that the following process is also applicable to cases where data is sent to the communication apparatus 1 from three or more linked apparatus.

The guaranteed rate guaranteeing the data transfer rate is individually prescribed for the linked apparatus 2 and 3, respectively. Herein, the communication controller 12 controls how the pause signal is transmitted by the pause signal transmitter 11 such that the data transfer rates from the linked apparatus 2 and 3 to the communication apparatus 1 become equal to or greater than the guaranteed rates corresponding to the linked apparatus 2 and 3, respectively.

For example, the communication controller 12 may control how the pause signal is transmitted such that the data transfer rates from the linked apparatus 2 and 3 to the communication apparatus 1 become equal to the guaranteed rates corresponding to the linked apparatus 2 and 3, respectively.

The communication controller 12 may also control how the pause signal is transmitted such that the data transfer rates from the linked apparatus 2 and 3 to the communication apparatus 1 become equal to the guaranteed rates corresponding to the linked apparatus 2 and 3 plus a predetermined added rate value.

In addition, the pause signal transmitter 11 and the communication controller 12 may be provided with the functions of devices such as an FPGA or DSP mounted on the interface board of a router or similar apparatus. Alternatively, the pause signal transmitter 11 and the communication controller 12 may be realized as a processor plus an FPGA or DSP.

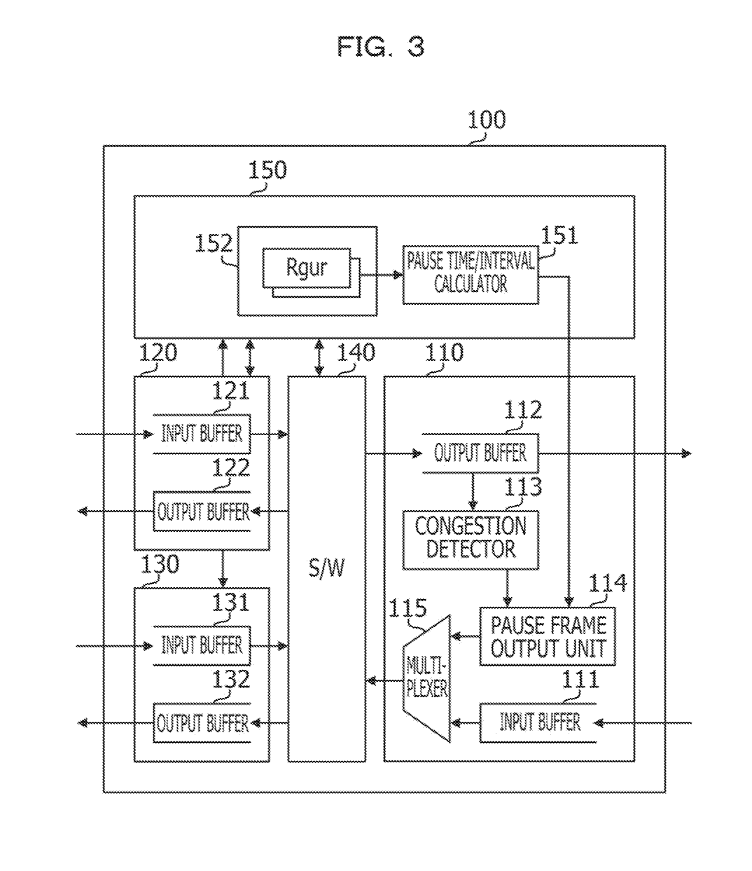

The pause signal transmitter 11 corresponds to the memory 152 and the pause time/interval calculator 151 inside the controller 150 illustrated in FIG. 3 and hereinafter described. The communication controller 12 corresponds to the output buffer 112, the congestion detector 113, and the PAUSE frame output unit 114 illustrated in FIG. 3.

Herein, the term “rate margin” will be used to refer to the value obtained by taking the sum of the guaranteed rates corresponding to the linked apparatus 2 and 3, and subtracting that sum value from a predetermined maximum rate. Herein, the sum of the guaranteed rates is taken to be less than or equal to the maximum rate. In this case, the added rate value described above is taken to be the value respectively allocated to the linked apparatus 2 and 3 after splitting the rate margin. For example, the added rate value may be the value obtained by dividing the rate margin by the number of linked apparatus 2 and 3. In this case, equal added rate values are allocated to each of the linked apparatus 2 and 3.

It should be appreciated that the maximum rate described above may be arbitrarily set by, for example, the administrator of the communication apparatus 1. For example, the maximum rate may be set according to factors such as the processing performance of the communication apparatus 1, or its current processing load. As another example, the communication apparatus 1 may include functions for forwarding data received from the linked apparatus 2 and 3 to another sender apparatus (not illustrated in the drawings) that is different from the linked apparatus 2 and 3. In this case, the maximum rate may be set equal to the maximum data transfer rate from the communication apparatus 1 to the sender apparatus. In any case, by splitting the rate margin and allocating the result to the linked apparatus 2 and 3 as an added rate value, data transfer rates from the linked apparatus 2 and 3 stop being overly constrained.

Furthermore, the added rate value may also differ for each of the linked apparatus 2 and 3 that receive the pause signal. For example, the added rate values allocated to the linked apparatus 2 and 3 may be the values obtained by splitting the rate margin using a ratio that depends on the magnitudes of the guaranteed rates. Alternatively, the added rate values allocated to the linked apparatus 2 and 3 may be values obtained by splitting the rate margin using a ratio that depends on the current data input rates into the communication apparatus 1 from the linked apparatus 2 and 3.

By transmitting the pause signal under the control of a communication controller 12 like the above, the data transfer rates from the linked apparatus 2 and 3 are kept at or above their respectively prescribed guaranteed rates, even when executing flow control.

Meanwhile, the communication apparatus 1 may also include a buffer 13 and a data size detector 14, as illustrated in FIG. 1. The buffer 13 temporarily stores data sent from a plurality of linked apparatus. The data size detector 14 monitors the size of data stored in the buffer 13, and detects whether or not the data size has reached a predetermined threshold value.

The buffer 13 herein may act as an incoming buffer that individually or collectively stores data respectively received from a plurality of linked apparatus, for example. If an incoming buffer is provided for each linked apparatus, then the data size detector 14 may, for example, compare the predetermined threshold value against the total data size inside all incoming buffers. As another example, the communication apparatus 1 may include functions for forwarding data received from the plurality of linked apparatus to another, separate sender apparatus. In this case, the buffer 13 may also act as an outgoing buffer that temporarily stores data to be forwarded to the sender apparatus.

Consider the case where the data size detector 14 detects that the data size in the buffer 13 is equal to or greater than a predetermined threshold value. In this case, the pause signal transmitter 11 may, for example, operate under control by the communication controller 12 and transmit the pause signal to the linked apparatus sending data to the communication apparatus 1.

It should be appreciated that the pause signal transmitter 11 may also transmit the pause signal irrespectively of the data size in the buffer 13. For example, the pause signal transmitter 11 may transmit the pause signal when there is a high processing load on the communication apparatus 1. Alternatively, the pause signal transmitter 11 may transmit the pause signal during a period set by the administrator of the communication apparatus 1, or by the administrator of a communication system that includes the communication apparatus 1.

Next, an example will be described for a communication system wherein a plurality of communication apparatus are connected by Ethernet. In addition, a LAN switch will be given herein as an example of a communication node that transmits the pause signal.

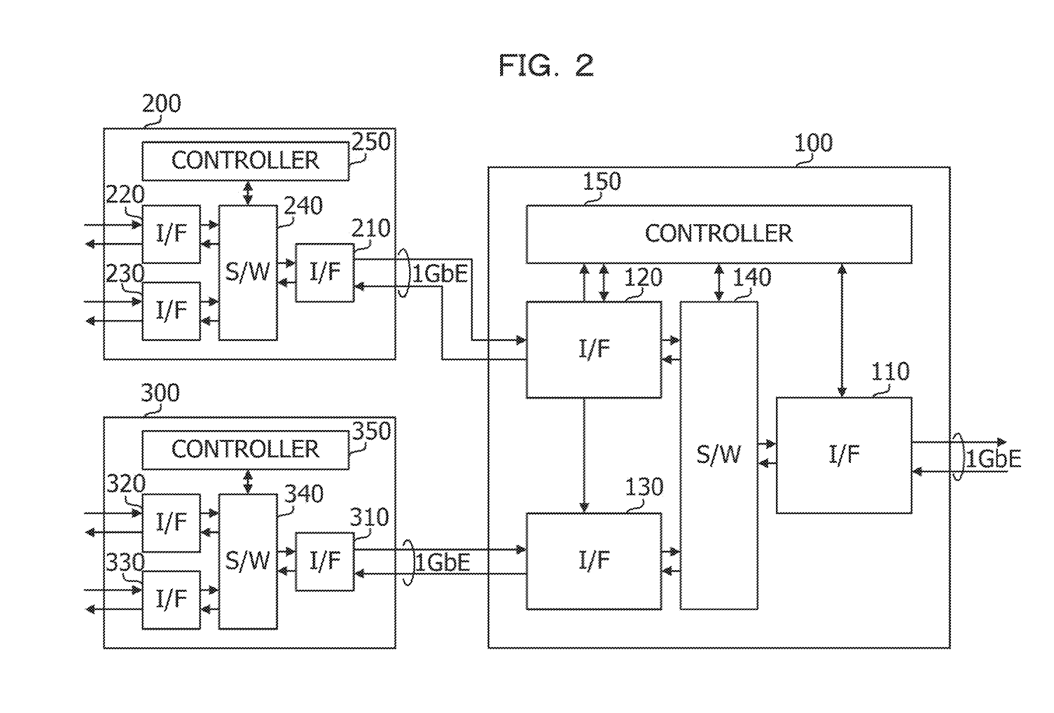

FIG. 2 illustrates the configuration of a communication system in accordance with a second embodiment.

The communication apparatus 100, 200, and 300 illustrated in FIG. 2 are each a single communication node connected by Ethernet. Each communication node is connected to other communication apparatus by Ethernet, sending and receiving signals. In the present embodiment, an Ethernet connection with a maximum transfer rate of 1 Gbps is adopted by way of example. The term “1 GbE” appearing in FIG. 2 indicates an Ethernet link with a maximum transfer rate of 1 Gbps.

The communication apparatus 100 is a LAN switch that accepts an incoming packet from another communication node, and sends the packet to a different communication node depending on the packet's destination. For example, the communication apparatus 100 may be a Layer 2 (L2) or a Layer 3 (L3) switch. The communication apparatus 100 includes interfaces (I/Fs) 110, 120, and 130, a switch (S/W) 140, and a controller 150.

The interfaces 110, 120, and 130 are each provided with respect to a particular communication port, sending and receiving data to and from other communication nodes via Ethernet. In the example in FIG. 2, the interface 120 is connected to the communication apparatus 200, while the interface 130 is connected to the communication apparatus 300. Meanwhile, the interface 110 is connected to another communication node not illustrated.

The switch 140 the respective data transmission channels among the interfaces 110, 120, and 130. The controller 150 controls the switching behavior of the switch 140 according to an incoming packet's destination. Also, as described later, the controller 150 outputs information required to transmit PAUSE frames to the interfaces 110, 120, and 130.

The communication apparatus 200 and 300 may be any apparatus provided with functions for sending and receiving signals via Ethernet. For example, the communication apparatus 200 and 300 may be LAN switches, or computers such as servers or client devices. The above also applies to the communication node not illustrated in FIG. 2 and connected to the interface 110.

By way of example, the communication apparatus 200 and 300 in FIG. 2 are taken to have substantially the same basic configuration as the communication apparatus 100. For example, the communication apparatus 200 may include interfaces 210, 220, and 230, a switch 240, and a controller 250. The interfaces 210, 220, and 230, the switch 240, and the controller 250 have configurations that respectively correspond to the interfaces 110, 120, and 130, the switch 140, and the controller 150 in the communication apparatus 100. In the example in FIG. 2, the interface 210 is connected to the communication apparatus 100, while the interfaces 220 and 230 are each connected to another communication node not illustrated.

Similarly, the communication apparatus 300 may include interfaces 310, 320, and 330, a switch 340, and a controller 350. The interfaces 310, 320, and 330, the switch 340, and the controller 350 have configurations that respectively correspond to the interfaces 110, 120, and 130, the switch 140, and the controller 150 in the communication apparatus 100. In the example in FIG. 2, the interface 310 is connected to the communication apparatus 100, while the interfaces 320 and 330 are each connected to another communication node not illustrated.

FIG. 3 illustrates the internal configuration of a communication apparatus in further detail. In the communication apparatus 100, the interface 110 includes an input buffer 111, an output buffer 112, a congestion detector 113, a PAUSE frame output unit 114, and a multiplexer 115.

The input buffer 111 temporarily stores incoming data from a communication node not illustrated, and outputs the stored incoming data to the multiplexer 115 according to the FIFO (First In, First Out) technique. The output buffer 112 temporarily stores outgoing data output from the switch 140, and outputs the stored outgoing data according to the FIFO technique. Herein, the outgoing data output from the output buffer 112 is send to another communication node via a Physical Layer (PHY) circuit not illustrated.

The congestion detector 113 monitors the data size of the data stored in the output buffer 112, and determines that congestion has occurred when the data size reaches a predetermined threshold value. Once congestion has been detected by the congestion detector 113, the PAUSE frame output unit 114 outputs a PAUSE frame to the multiplexer 115 on the basis of a pause time and a pause interval acquired from the controller 150.

The multiplexer 115 outputs one of the following to the switch 140: incoming data output from the input buffer 111; or a PAUSE frame output from the PAUSE frame output unit 114. Herein, a communication node to which a PAUSE frame is addressed will be referred to as an “upstream node”. For example, if congestion is detected by the congestion detector 113 when incoming data from the communication apparatus 200 and 300 is forwarded to the output buffer 112 of the interface 110, then the communication apparatus 200 and 300 will become the recipients of PAUSE frames, and thus become upstream nodes.

If a PAUSE frame is output from the PAUSE frame output unit 114, then the multiplexer 115 outputs that PAUSE frame to the switch 140. If a PAUSE frame is not being output, then the leading incoming data in the input buffer 111 is output to the switch 140.

Herein, since the guaranteed rate differs for each upstream node as described later, the PAUSE frame output unit 114 generates an individual PAUSE frame to be respectively transmitted to each upstream node. These generated PAUSE frames are then output to the multiplexer 115. At this point, the PAUSE frame output unit 114 may, for example, attach to each PAUSE frame a local header, which is used internally inside the communication apparatus 100. In each local header, there may be written identification information, which identifies the interface or port corresponding to a particular upstream node.

In this case, a similar local header is attached to the frame output to the multiplexer 115 from the input buffer 111. In the local header, there is written identification information, which identifies the interface or port corresponding to that frame's destination. The writing of identification information to the local header may be executed under control by the controller 150, for example. In this case, the switch 140 references the local header of an input frame, and forwards the frame to the output buffer of the interface corresponding to the identification information. The local header is then removed at the time the frame is stored in the output buffer of the interface corresponding to the destination.

The interfaces 120 and 130 both have substantially the same configuration as the interface 110. However, in FIG. 3, only the input buffer 121 and the output buffer 122 are illustrated in the interface 120, and only the input buffer 131 and the output buffer 132 are illustrated in the interface 130.

The controller 150 includes a pause time/interval calculator 151. The pause time/interval calculator 151 calculates the following: a pause time PT, which indicates the amount of time to pause the transmission of data by data-originating communication nodes; and a pause interval PI, which indicates the interval at which to start the pause operation (where PI≧PT). The calculated pause time PT and pause interval PI are then output to the PAUSE frame output unit 114. The pause time/interval calculator 151 calculates the above pause time PT and pause interval PI for each data-originating communication node on the basis of the guaranteed rates, which indicate the transfer rates guaranteed for each data-originating communication node. In the present embodiment, respective guaranteed rates are prescribed for the communication apparatus 200 and 300, and thus the pause time PT and the pause interval PI are respectively calculated for the communication apparatus 200 and 300.

Herein, the guaranteed rate for each communication node may be stored in the memory 152 provided in the controller 150, and read out by the pause time/interval calculator 151, for example. The guaranteed rates may be stored in the memory 152 in advance, or alternatively, stored in the memory 152 according to user input operations.

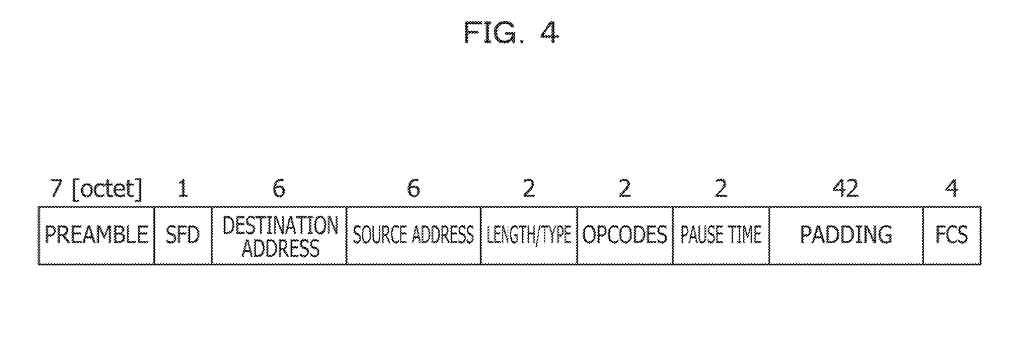

FIG. 4 illustrates the content of a PAUSE frame. A PAUSE frame includes: a Preamble, which includes a sync signal; a Start Frame Delimiter (SFD), which indicates the start of a Medium Access Control (MAC) frame; the destination address; the source address; information indicating length and type; operation codes; the pause time; padding; and a Frame Check Sequence (FCS) for checking the MAC frame. A communication node receiving a PAUSE frame will pause transmission of data to the communication node that originated the PAUSE frame, for the amount of time stated in the pause time area.

Herein, 512-bit data is stored in the pause time area. On an Ethernet with a transfer rate of 1 Gbps, the pause time resolution inside the PAUSE frame thus becomes 10⁻⁹×512=0.512 μs. Meanwhile, the maximum value for the pause time that may be set in a single PAUSE frame becomes 0.512×65535≅33.5 ms.

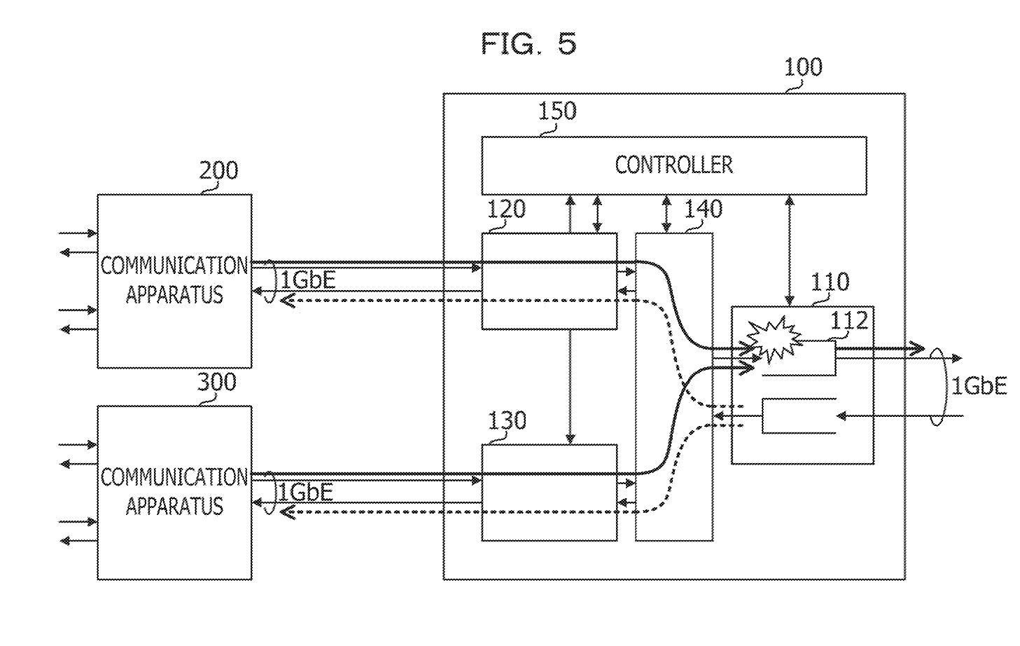

A process will now be described for the case where congestion is detected in the communication apparatus 100 while the communication apparatus 100 receives data from the communication apparatus 200 and 300. FIG. 5 is a diagram for explaining a flow control executed in the second embodiment.

In the example in FIG. 5, a guaranteed rate of 500 Mbps is prescribed for the communication apparatus 200, while a guaranteed rate of 250 Mbps is prescribed for the communication apparatus 300. Herein, data is sent from the communication apparatus 200 to the communication apparatus 100. After being received at the communication apparatus 100, this data is sent via the interface 110 to another communication node connected to the interface 110. Meanwhile, data is also sent from the communication apparatus 300 to the communication apparatus 100. After being received at the communication apparatus 100, this data is sent via the interface 110 to another communication node connected to the interface 110.

As traffic increases from the communication apparatus 200 and 300 to the communication apparatus 100, the data size increases in the output buffer 112 inside the interface 110 at the communication apparatus 100. If the data size in the output buffer 112 becomes equal to or greater than a predetermined threshold value, then the communication apparatus 100 determines that congestion has occurred. As illustrated by way of example in FIG. 5, data is sent from the communication apparatus 200 to the communication apparatus 100 at a rate of 800 Mbps, while data is sent from the communication apparatus 300 to the communication apparatus 100 at a rate of 400 Mbps. In this case, the incoming data traffic exceeds the allowable amount of traffic on the output transmission line connected to the interface 110 of the communication apparatus 100. For this reason, the data size in the output buffer 112 inside the interface 110 will gradually increase.

If the data size in the output buffer 112 becomes equal to or greater than a predetermined threshold value, then the communication apparatus 100 will transmit a PAUSE frame to the communication apparatus 200 and 300, and request that data transmission to the communication apparatus 100 be temporarily paused. In the present embodiment, the communication apparatus 100 transmits a PAUSE frame to the communication apparatus 200 such that the data transfer rate from the communication apparatus 200 becomes equal to the guaranteed rate prescribed for the communication apparatus 200. Likewise, the communication apparatus 100 transmits a PAUSE frame to the communication apparatus 300 such that the data transfer rate from the communication apparatus 300 becomes equal to the guaranteed rate prescribed for the communication apparatus 300.

For example, since the maximum transfer rate is 1 Gbps on the transmission line between the communication apparatus 200 and the communication apparatus 100, the communication apparatus 100 may transmit a PAUSE frame to the communication apparatus 200 such that the pause time PT becomes 500 us and the pause interval PI becomes 1 ms. At this point, the communication apparatus 200 will pause data transmission to the communication apparatus 100 for a period of 500 μs, and then execute data transmission to the communication apparatus 100 for a subsequent period of 500 μs. In so doing, the data transfer rate from the communication apparatus 200 to the communication apparatus 100 is constrained to 500 Mbps, the same value as the guaranteed rate prescribed for the communication apparatus 200.

In addition, the communication apparatus 100 may, for example, transmit a PAUSE frame to the communication apparatus 300 such that the pause time PT becomes 750 μs and the pause interval PI becomes 1 ms. At this point, the communication apparatus 300 will pause data transmission to the communication apparatus 100 for a period of 750 μs, and then execute data transmission to the communication apparatus 100 for a subsequent period of 250 μs. In so doing, the data transfer rate from the communication apparatus 300 to the communication apparatus 100 is constrained to 250 Mbps, the same value as the guaranteed rate prescribed for the communication apparatus 300.

The pause time PT and the pause interval PI are calculated by the pause time/interval calculator 151 of the controller 150 for each upstream node set as a PAUSE frame recipient. Herein, if Rgur is taken to the guaranteed rate prescribed for an upstream node, and if Rmax is taken to be the maximum transfer rate on the transmission lines between communication nodes (where Rmax≧Rgur), then the following relationship holds: Rgur/Rmax=PT/PI. From this relationship, the pause time/interval calculator 151 computes the pause time PT and the pause interval PI so as to satisfy the following Eq. 1.

PT=(Rgur/Rmax)×PI (1)

The pause time/interval calculator 151 reads out the guaranteed rate for each upstream node from the memory 152 as described earlier, and then calculates the pause time PT and the pause interval PI for each upstream node in accordance with the above Eq. 1. Subsequently, the pause time/interval calculator 151 outputs the calculated pause time PT and pause interval PI to the PAUSE frame output unit 114.

If congestion has been detected by the congestion detector 113, then the PAUSE frame output unit 114 respectively acquires the pause times PT and the pause interval PI corresponding to each upstream node from the pause time/interval calculator 151. Subsequently, the PAUSE frame output unit 114 generates a PAUSE frame for each upstream node, and outputs the generated PAUSE frames to the multiplexer 115.

As long as there is no change in the guaranteed rates prescribed for the communication nodes set as PAUSE frame recipients, there will be no change in the pause time PT and the pause interval PI corresponding to each communication node. For this reason, the pause time/interval calculator 151 may also calculate the pause times PT and the pause intervals PI when the communication apparatus 100 is powered on, for example. In addition, the pause time/interval calculator 151 may also calculate the pause times PT and the pause intervals PI in particular cases, such as when the guaranteed rates are updated in the memory 152, or when a new guaranteed rate is stored in the memory 152.

Furthermore, the pause time/interval calculator 151 may also determine the pause times PT and the pause intervals PI by referencing a table that stores a combination of a pause time PT and a pause interval PI for each communication node, for example. Each combination of a pause time PT and a pause interval PI stored in the table satisfies the above Eq. 1. In this case, the table may be stored in the memory 152, for example.

In addition, the pause times PT and the pause intervals PI calculated by the pause time/interval calculator 151 may also be stored in memory or similar storage inside the PAUSE frame output unit 114.

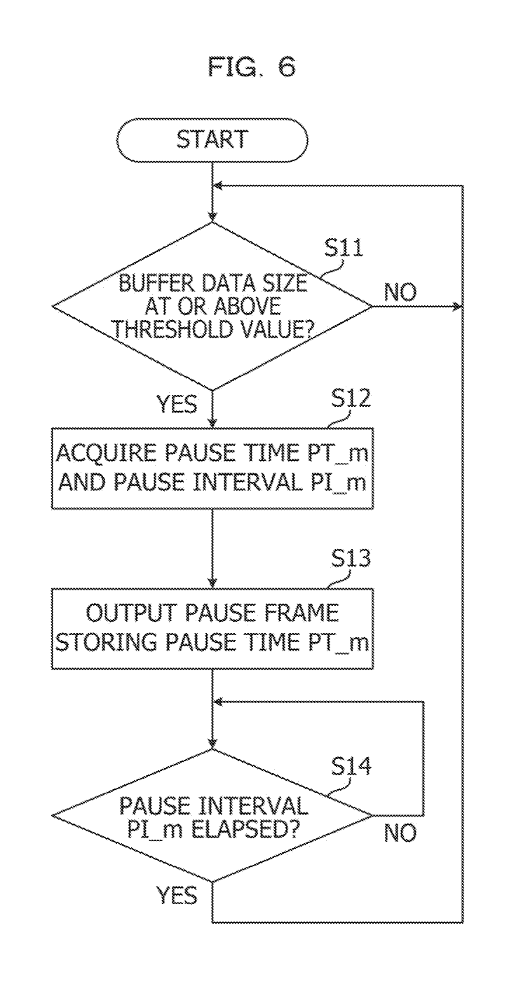

FIG. 6 is a flowchart illustrating a PAUSE frame output processing sequence.

The following process illustrated in FIG. 6 is executed for each upstream node. Herein, when given the mth upstream node (where m is a natural number) from among a plurality of upstream nodes set as PAUSE frame recipients, the pause time PT and the pause interval PI used when transmitting a PAUSE frame to the mth upstream node are taken to be PT_m and PI_m, respectively.

[Step S11] On the basis of detection results from the congestion detector 113, the PAUSE frame output unit 114 determines whether or not the data size in the output buffer 112 is equal to or greater than a predetermined threshold value. The PAUSE frame output unit 114 may repeat this determination process at a fixed interval, for example. If it is determined that the data size is equal to or greater than the threshold value, then the processing in step S12 is executed.

[Step S12] The PAUSE frame output unit 114 acquires the pause time PT_m and the pause interval PI_m from the pause time/interval calculator 151. It should be appreciated that this information may also be acquired in advance, such as when the communication apparatus 100 is powered on, for example.

[Step S13] The PAUSE frame output unit 114 generates a PAUSE frame that includes the pause time PT_m, and outputs the generated PAUSE frame to the multiplexer 115. This PAUSE frame is passed to the interface corresponding to the mth upstream node (such as the interface 120, for example) via the switch 140, and then transmitted to the upstream node (such as the communication apparatus 200, for example). Having received the PAUSE frame, the upstream node pauses data transmission to the communication apparatus 100 for the duration of the pause time PT_m. In addition, if another PAUSE frame is not received once the pause time PT_m has elapsed, then the upstream node resumes data transmission to the communication apparatus 100.

Herein, step S13, processing like the following may also be executed. First, the PAUSE frame output unit 114 outputs to the multiplexer 115 a PAUSE frame that includes the maximum value for the pause time. The communication node receiving this PAUSE frame then pauses data transmission to the communication apparatus 100. Next, the PAUSE frame output unit 114 starts a time count, and once the pause time PT_m has elapsed, outputs to the multiplexer 115 a PAUSE frame that includes “0” as the pause time. The communication node receiving this PAUSE frame will determine that the data transmission pause request has been canceled, and will then resume data transmission to the communication apparatus 100.

[Step S14] The PAUSE frame output unit 114 starts a time count kept by a counter or other internally-provided component, and determines whether or not the pause interval PI_m has elapsed. Once the pause interval PI_m has elapsed, the processing in step S11 is executed again.

Herein, when the pause time/interval calculator 151 calculates the pause time PT and the pause interval PI so as to satisfy the above Eq. 1, a common value may be used for the pause interval PI corresponding to each upstream node, for example. In this case, the processing of the respective steps in FIG. 6 may be conducted at parallel timings for each upstream node.

As a result of the communication apparatus 100 conducting a flow control in the second embodiment described above, the data transfer rate from an upstream node is constrained to the guaranteed rate prescribed for that upstream node. Consequently, a network with a guaranteed output rate may be easily constructed.

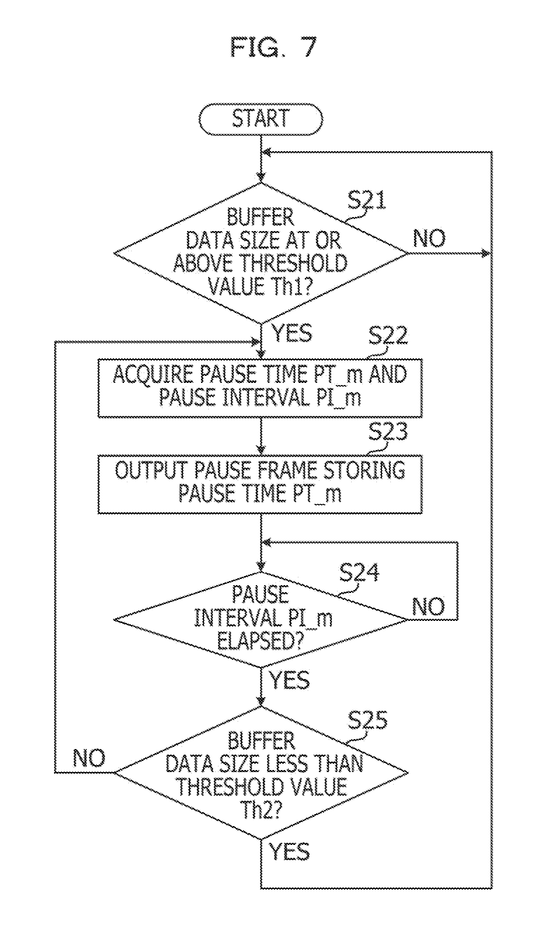

Meanwhile, in the above process illustrated in FIG. 6, the desire to transmit a PAUSE frame is determined by comparing the data size in the output buffer 112 to a single threshold value. However, as illustrated in FIG. 7, this process for determining whether or not to transmit a PAUSE frame may also conducted using two threshold values Th1 and Th2 (where Th1>Th2). Herein, when executing the process illustrated in FIG. 7, the congestion detector 113 notifies the PAUSE frame output unit 114 of the following: detection results that indicate whether or not the data size in the output buffer 112 is equal to or greater than the threshold value Th1; and detection results that indicate whether or not the data size is less than the threshold value Th2.

FIG. 7 is a flowchart illustrating another example of a PAUSE frame output processing sequence.

[Step S21] On the basis of detection results from the congestion detector 113, the PAUSE frame output unit 114 determines whether or not the data size in the output buffer 112 is equal to or greater than the threshold value Th1. The PAUSE frame output unit 114 may repeat this determination process at a fixed interval, for example. If it is determined that the data size is equal to or greater than the threshold value Th1, then the processing in step S22 is executed.

[Step S22] In this step, processing similar to that of step S12 in FIG. 6 is executed. In other words, the PAUSE frame output unit 114 acquires the pause time PT_m and the pause interval PI_m from the pause time/interval calculator 151.

[Step S23] In this step, processing similar to that of step S13 in FIG. 6 is executed. In other words, the PAUSE frame output unit 114 generates a PAUSE frame that includes the pause time PT_m, and outputs the generated PAUSE frame to the multiplexer 115.

[Step S24] In this step, processing similar to that of step S14 in FIG. 6 is executed. In other words, the PAUSE frame output unit 114 determines whether or not the pause interval PI_m has elapsed. Once the pause interval PI_m has elapsed, the processing in step S25 is executed.

[Step S25] On the basis of detection results from the congestion detector 113, the PAUSE frame output unit 114 determines whether or not the data size in the output buffer 112 is less than the threshold value Th2. If the data size is less than the threshold value Th2, then the processing in step S21 is executed again. If the data size is equal to or greater than the threshold value Th2, then the processing in step S22 is executed again.

According to the process illustrated in FIG. 7, the communication apparatus 100 is not as frequently switched between a constrained traffic state and a free traffic state compared to the process illustrated in FIG. 6.

In the second embodiment described above, the communication apparatus 100 conducts a flow control such that the data output rates from the communication apparatus 200 and 300 maintain the guaranteed rates respectively prescribed for the communication apparatus 200 and 300. However, when such a flow control is in effect, the combined data output rate from the communication apparatus 200 and 300 might fall lower than the maximum transfer rate Rmax on the transmission lines between communication nodes. In other words, there might be leftover data bandwidth on the transmission line on the output side of the interface 110 in the communication apparatus 100. In contrast, in the third embodiment described hereinafter, a flow control is conducted such that the total data transfer rate from the communication apparatus 200 and 300 becomes equal to the maximum transfer rate Rmax on the transmission lines between communication nodes.

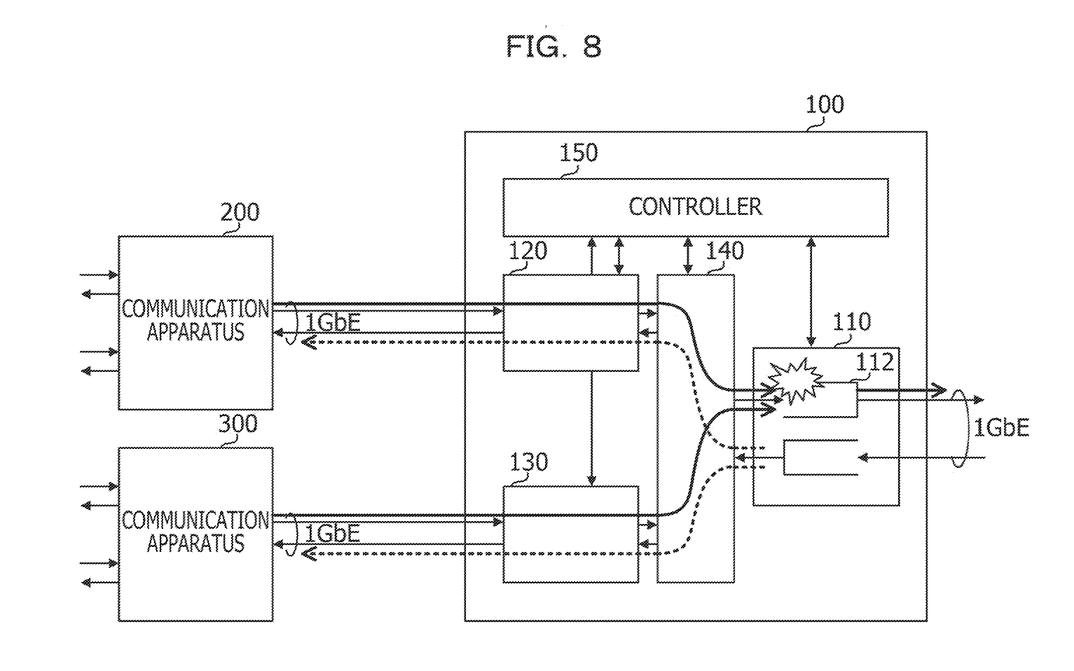

FIG. 8 is a diagram for explaining a flow control executed in the third embodiment. In the present embodiment, the internal configurations of the communication apparatus 100 to 300 are basically similar to those of the second embodiment, and thus their description is omitted herein. However, the sequence for calculating the pause time PT and the pause interval PI in the pause time/interval calculator 151 provided in the controller 150 differs from that of the second embodiment.

The example in FIG. 8 is similar to the example in FIG. 5, in that a guaranteed rate of 500 Mbps is prescribed for the communication apparatus 200, and a guaranteed rate of 250 Mbps is prescribed for the communication apparatus 300. By way of example herein, data is sent from the communication apparatus 200 to the communication apparatus 100 at a rate of 800 Mbps, while data is sent from the communication apparatus 300 to the communication apparatus 100 at a rate of 400 Mbps. In the communication apparatus 100, the data size increases in the output buffer 112 inside the interface 110, and when the data size in the output buffer 112 becomes equal to or greater than a predetermined threshold value, the congestion detector 113 in the communication apparatus 100 determines that congestion has occurred.

If the data size in the output buffer 112 becomes equal to or greater than a predetermined threshold value, then the communication apparatus 100 will transmit a PAUSE frame to the communication apparatus 200 and 300, and request that data transmission to the communication apparatus 100 be temporarily paused. In the present embodiment, the pause time/interval calculator 151 of the controller 150 calculates the pause time PT and the pause interval PI with the following sequence.

Herein, when given the mth upstream node from among a plurality of upstream nodes set as PAUSE frame recipients, the guaranteed rate prescribed for the mth upstream node is taken to be Rgur_m. The communication apparatus 100 transmits a PAUSE frame to the mth upstream node such that the data transfer rate Rout_m from the mth upstream node becomes equal to a value computed using the following Eq. 2.

Rout_{—}m=Rgur_{—}m+Radd (2)

Herein, Radd is an added rate value that is added to the guaranteed rate Rgur_m. The same value for Radd is used for all upstream nodes, and is computed according to the following Eq. 3. In Eq. 3, Rtot expresses the total guaranteed rate obtained by summing the guaranteed rates Rgur prescribed for each upstream node, while n expresses the number of upstream nodes (where n≧2).

Radd=(Rmax−Rtot)/n (3)

Following the above Eqs. 2 and 3, the pause time/interval calculator 151 calculates the data transfer rate Rout_m from the mth upstream node. If the pause time PT and the pause interval PI corresponding to the mth upstream node are taken to be PT_m and PI_m, respectively, then the following relationship holds: Rout_m/Rmax=PT_m/PI_m. From this relationship, the pause time/interval calculator 151 computes the pause time PT_m and the pause interval PI_m so as to satisfy the following Eq. 4.

PT_{—}m=(Rout_{—}m/Rmax)×PI_{—}m (4)

On the basis of the pause time PT_m and the pause interval PI_m from the pause time/interval calculator 151, the PAUSE frame output unit 114 of the communication apparatus 100 transmits a PAUSE frame in accordance with the processing sequence in FIG. 6 or 7.

In the example illustrated in FIG. 8, the added rate value Radd is computed to be 125 Mbps according to Eq. 3. Consequently, the data transfer rate Rout for the communication apparatus 200 becomes 625 Mbps according to Eq. 2. The communication apparatus 100 transmits a PAUSE frame to the communication apparatus 200 such that the pause time PT becomes 625 μs and the pause interval PI becomes 1 ms, for example. In so doing, the data transfer rate from the communication apparatus 200 is maintained at 625 Mbps. Meanwhile, the data transfer rate for the communication apparatus 300 becomes 375 Mbps according to Eq. 2. The communication apparatus 100 transmits a PAUSE frame to the communication apparatus 300 such that the pause time PT becomes 375 μs and the pause interval PI becomes 1 ms, for example. In so doing, the data transfer rate from the communication apparatus 300 is maintained at 375 Mbps.

According to the above process, the communication apparatus 100 conducts a flow control such that the data transfer rate Rout_m from the mth upstream node is maintained at or above the guaranteed rate Rgur_m. Furthermore, the communication apparatus 100 takes the rate margin expressed in Eq. 3 as (Rmax−Rtot), and equally distributes this rate margin among the respective upstream nodes. In other words, the data transfer rate from the mth upstream node becomes a value equal to the guaranteed rate Rgur_m plus the additional added rate value Radd. According to such a process, data can be transmitted using the maximum data bandwidth on the transmission line on the output side of the interface 110 in the communication apparatus 100, thereby improving the data transmission efficiency.

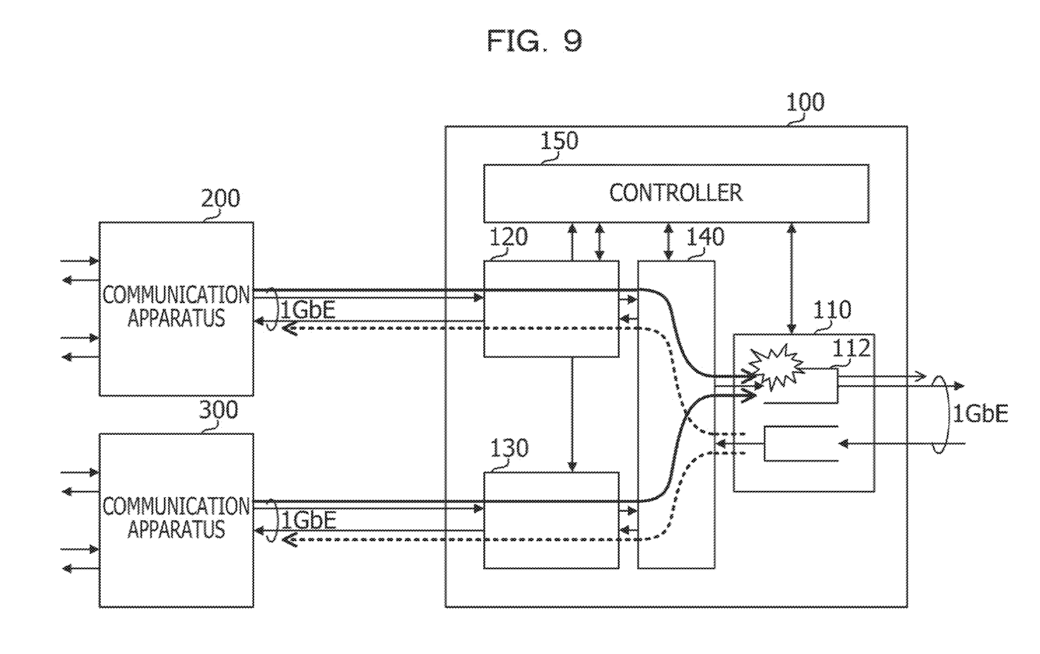

FIG. 9 is a diagram for explaining a flow control executed in a fourth embodiment. In the present embodiment, the internal configurations of the communication apparatus 100 to 300 are basically similar to those of the second and third embodiments, and thus their description is omitted herein. Also, similarly to the third embodiment, a flow control is conducted by the communication apparatus 100 in the present embodiment such that total data transfer rate from the communication apparatus 200 and 300 becomes equal to the maximum transfer rate Rmax on the transmission lines between communication nodes. However, the present embodiment differs from the third embodiment in that the pause time/interval calculator 151 provided in the controller 150 of the communication apparatus 100 takes the rate margin expressed in Eq. 3 as (Rmax−Rtot), and distributes this rate margin according to the magnitudes of the guaranteed rates Rgur prescribed for the upstream nodes.

In the present embodiment, the communication apparatus 100 transmits a PAUSE frame to the mth upstream node such that the data transfer rate Rout_m from the mth upstream node becomes equal to a value computed using the following Eq. 5.

Rout_{—}m=Rgur_{—}m+Radd_{—}m (5)

Herein, Radd_m is the added rate value allocated to the mth upstream node. Radd_m is individually computed for each upstream node according to the following Eq. 6.

Radd_{—}m=(Rmax−Rtot)×(Rgur_{—}m/Rtot) (6)

Following the above Eqs. 5 and 6, the pause time/interval calculator 151 calculates the data transfer rate Rout_m from the mth upstream node. Since the relationship Rout_m/Rmax=PT_m/PI_m holds, the pause time/interval calculator 151 computes the pause time PT_m and the pause interval PI_m so as to satisfy the earlier Eq. 4. On the basis of the pause time PT_m and the pause interval PI_m from the pause time/interval calculator 151, the PAUSE frame output unit 114 of the communication apparatus 100 transmits a PAUSE frame in accordance with the processing sequence in FIG. 6 or 7.

The example in FIG. 9 is similar to the examples in FIGS. 5 and 8, in that a guaranteed rate of 500 Mbps is prescribed for the communication apparatus 200, and a guaranteed rate of 250 Mbps is prescribed for the communication apparatus 300. In this case, the added rate value for the communication apparatus 200 is computed by Eq. 6 to be 166 Mbps. Consequently, the data transfer rate Rout for the communication apparatus 200 becomes 666 Mbps according to Eq. 5. The communication apparatus 100 transmits a PAUSE frame to the communication apparatus 200 such that the pause time PT becomes 666 μs and the pause interval PI becomes 1 ms, for example. In so doing, the data transfer rate from the communication apparatus 200 is maintained at 666 Mbps.

Meanwhile, the added rate value for the communication apparatus 300 is computed by Eq. 6 to be 83 Mbps. Consequently, the data transfer rate Rout for the communication apparatus 300 becomes 333 Mbps according to Eq. 5. The communication apparatus 100 transmits a PAUSE frame to the communication apparatus 300 such that the pause time PT becomes 333 μs and the pause interval PI becomes 1 ms, for example. In so doing, the data transfer rate from the communication apparatus 300 is maintained at 333 Mbps.

According to the above process, a flow control is conducted by the communication apparatus 100 such that the data transfer rate to the communication apparatus 100 increases for upstream nodes with increasingly larger guaranteed rates Rgur. Consequently, data transmission efficiency is improved along the transmission line on the output side of the interface 110 in the communication apparatus 100. Moreover, the transmission efficiency may also be increased along the transmission lines that lead from the flow-controlled communication nodes to the communication apparatus 100.

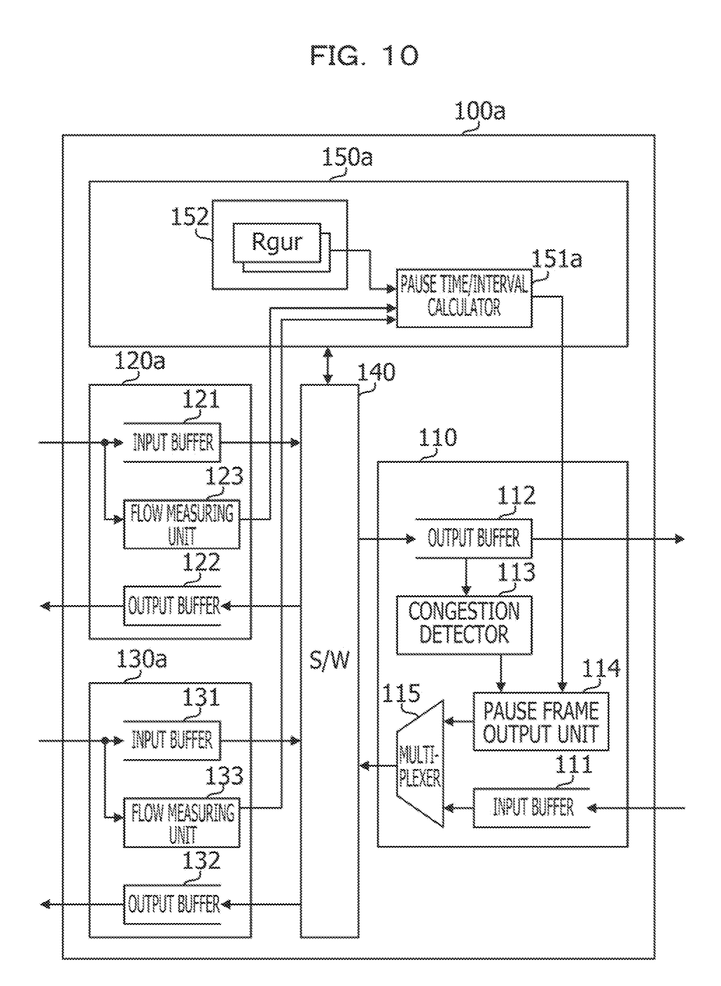

FIG. 10 illustrates the internal configuration of a communication apparatus in accordance with a fifth embodiment. In FIG. 10, identical reference numbers are used for component elements that are identical to those in FIG. 3.

The communication apparatus 100a illustrated in FIG. 10 includes interfaces 110, 120a, 130a, a switch 140, and a controller 150a. The interface 120a has a configuration corresponding to that of the interface 120 illustrated in FIG. 3. In other words, the interface 120a is provided with an input buffer 121 and an output buffer 122, and is configured to send and receive data to and from the communication apparatus 200. Additionally, the interface 120a is provided with a flow measuring unit 123, which measures the amount of data per unit time being input into the interface 120a.

Similarly, the interface 130a has a configuration corresponding to that of the interface 130 illustrated in FIG. 3. In other words, the interface 130a is provided with an input buffer 121 and an output buffer 122, and is configured to send and receive data to and from the communication apparatus 300. Additionally, the interface 130a is provided with a flow measuring unit 133, which measures the data flow (i.e., the amount of data per unit time) being input into the interface 130a.

The controller 150a has a configuration corresponding to that of the controller 150 illustrated in FIG. 3, being provided with memory 152 for storing guaranteed rates Rgur respectively prescribed for upstream nodes. In addition, the controller 150a is also provided with a pause time/interval calculator 151a.

Similarly to the pause time/interval calculator 151 illustrated in FIG. 3, the pause time/interval calculator 151a calculates, for each upstream node, the pause time PT and the pause interval PI used when transmitting a PAUSE frame. However, the pause time/interval calculator 151a dynamically calculates pause times PT and pause intervals PI according to measurement results from the flow measuring units 123 and 133 provided in the interfaces 120a and 130a, respectively. The pause time/interval calculator 151a then outputs the calculated results to the PAUSE frame output unit 114. The pause time/interval calculator 151a takes the rate margin expressed in Eqs. 3 and 6 as (Rmax−Rtot), and distributes this rate margin according to flow rates measured by the flow measuring units 123 and 133.

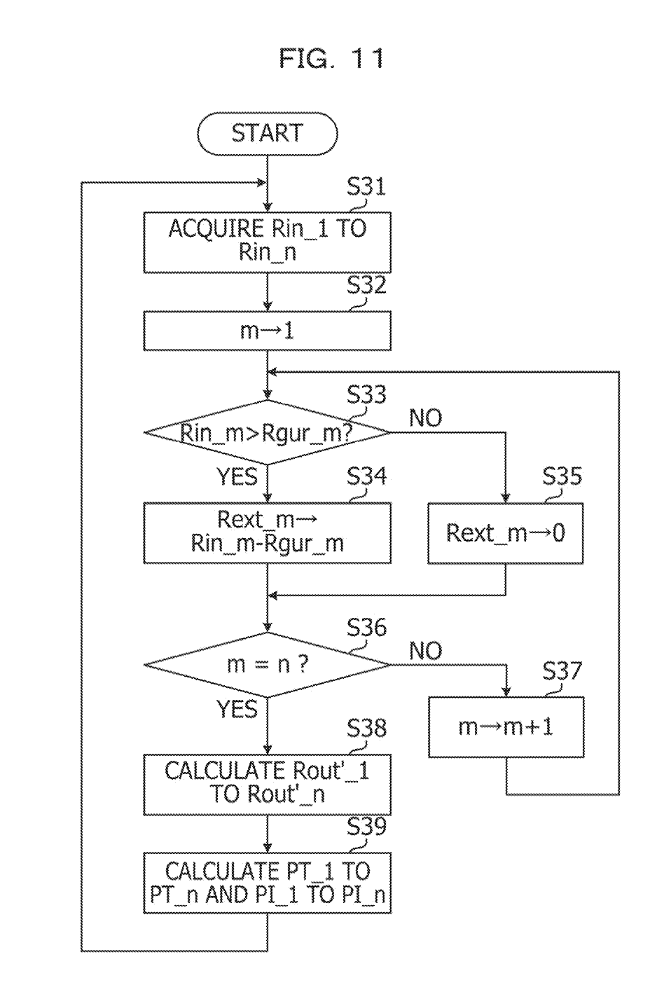

FIG. 11 is a flowchart illustrating a processing sequence for calculating the pause time and the pause interval. In FIG. 11, there exist n upstream nodes that receive a PAUSE frame, with pause times PT_1 to PT_n and pause intervals PI_1 to PI_n being computed for use when respectively transmitting a PAUSE frame to these upstream nodes.

[Step S31] From the respective flow measuring units for each interface (such as the flow measuring units 123 and 133, for example), the pause time/interval calculator 151a acquires the flow rates Rin_1 to Rin_n of data being respectively input into the n interfaces (such as the interfaces 120a and 130a, for example).

[Step S32] The pause time/interval calculator 151a sets a variable m equal to 1.

[Step S33] The pause time/interval calculator 151a determines whether or not the flow rate Rin_m from the mth upstream node is greater than the guaranteed rate Rgur_m prescribed for that upstream node. If the flow rate Rin_m is greater than the guaranteed rate Rgur_m, then the processing step S34 is executed. If the flow rate Rin_m is less than or equal to the guaranteed rate Rgur_m, then the processing in step S35 is executed.

[Step S34] The pause time/interval calculator 151a computes the extra rate Rext_m by subtracting the guaranteed rate Rgur_m from the flow rate Rin_m. This extra rate Rext_m expresses the magnitude of the flow rate Rin_m from the mth upstream node with respect to guaranteed rate Rgur_m prescribed for that upstream node.

[Step S35] The pause time/interval calculator 151a sets extra rate Rext_m equal to 0.

[Step S36] The pause time/interval calculator 151a determines whether or not the variable m is equal to n. If the variable m is less than n, then the processing in step S37 is executed. If the variable m is equal to n, then the processing in step S38 is executed.

[Step S37] The pause time/interval calculator 151a increments the variable m by 1. Subsequently, the processing in step S33 is once again executed for another upstream node.

[Step S38] The pause time/interval calculator 151a calculates data transfer rates Rout′_1 to Rout′_n, which respectively correspond to each of the n upstream nodes. The data transfer rate Rout′_m corresponding to the mth upstream node is computed according to the following Eq. 7.

Rout′_{—}m=Rgur_{—}m+Radd′_{—}m (7)

Herein, in Eq. 7, Radd′_m is the added rate value allocated to the mth upstream node, and is computed according to the following Eq. 8. In addition, in Eq. 8, Rextot is the sum of all extra rates computed for the n upstream nodes in step S34 or S35. Rextot is computed according to Eq. 9.

Radd′_{—}m=(Rmax=Rtot)×Rext_{—}m/Rextot (8)

Rextot=Rext_{—}1+Rext_{—}2+ . . . +Rext_{—}n (9)

[Step S39] The pause time/interval calculator 151a calculates the pause times PT_1 to PT_n and the pause intervals PI_1 to PI_n corresponding to each of the n upstream nodes. Since the relationship Rout′_m/Rmax=PT_m/PI_m holds, the pause time/interval calculator 151a computes the pause time PT_m and the pause interval PI_m so as to satisfy the following Eq. 10.

PT_{—}m=(Rout′_{—}m/Rmax)×PI_{—}m (10)

The processing in the above steps S31 to S39 may be repeatedly executed at a fixed interval, for example. On the basis of the pause time PT_m and the pause interval PI_m from the pause time/interval calculator 151a, the PAUSE frame output unit 114 of the communication apparatus 100a transmits a PAUSE frame in accordance with the processing sequence in FIG. 6 or 7. However, in step S12 of FIG. 6 or step S22 of FIG. 7, the PAUSE frame output unit 114 acquires the pause time PT_m and the pause interval PI_m most recently computed by the pause time/interval calculator 151a at that time.

The processing in the above steps S31 to S39 may also be repeatedly executed in the state where congestion has been detected (in other words, only in the state where the data size in the output buffer 112 is equal to or greater than a predetermined threshold value).

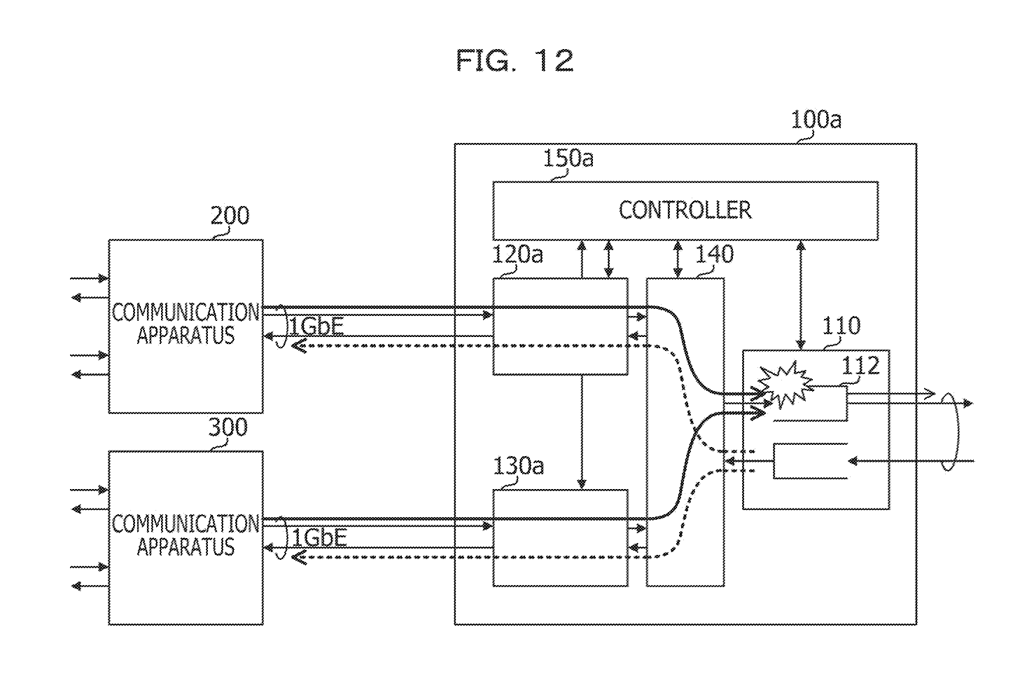

FIG. 12 is a diagram for explaining an example of a flow control executed in the fifth embodiment. In the example illustrated in FIG. 12, a guaranteed rate of 500 Mbps is prescribed for the communication apparatus 200, while a guaranteed rate of 250 Mbps is prescribed for the communication apparatus 300. In addition, at the time when the interface 110 of the communication apparatus 100a detects congestion, the flow rate from the communication apparatus 200 to the communication apparatus 100a is taken to be 800 Mbps, while the flow rate from the communication apparatus 300 to the communication apparatus 100a is taken to be 250 Mbps.

In this case, the added rate value in Eq. 7 for the communication apparatus 200 is computed to be 250 Mbps. Thus, the communication apparatus 100a transmits a PAUSE frame to the communication apparatus 200 such that the data transfer rate from the communication apparatus 200 becomes 750 Mbps. For example, a PAUSE frame may be transmitted such that the pause time PT becomes 750 μs and the pause interval PI becomes 1 ms.

Meanwhile, the added rate value in Eq. 7 for the communication apparatus 300 is computed to be 0. Thus, the communication apparatus 100a transmits a PAUSE frame to the communication apparatus 300 such that the data transfer rate from the communication apparatus 300 becomes 250 Mbps. For example, a PAUSE frame may be transmitted such that the pause time PT becomes 250 μs and the pause interval PI becomes 1 ms.

Herein, in the above process illustrated in FIG. 11, the upstream nodes set as recipients of a PAUSE frame may also include upstream nodes whose flow rate with respect to the communication apparatus 100a is less than or equal to the guaranteed rate. In other words, in order to make the data transfer rate Rout′ calculated in step S38 match the guaranteed rate Rgur, a PAUSE frame may be transmitted such that the data transfer rate becomes equal to the guaranteed rate.

However, it is also possible to not transmit a PAUSE frame to upstream nodes whose measured flow rate is less than or equal to the guaranteed rate. For example, when calculating the pause time PT_m and the pause interval PI_m for the mth upstream node in step S39, the process may be configured to not compute the pause time PT_m and the pause interval PI_m if the corresponding extra rate Rext_m is 0. In this case, the PAUSE frame output unit 114 is configured to not output a PAUSE frame to upstream nodes whose pause time PT and pause interval PI have not been output from the pause time/interval calculator 151a. The PAUSE frame output unit 114 does not output a PAUSE frame to such upstream nodes, even if the data size in the output buffer 112 is equal to or greater than the threshold value. In the example illustrated in FIG. 12, a PAUSE frame is not output to the communication apparatus 300.

In addition, in the above process illustrated in FIG. 11, the extra rate Rext_m is set to 0 in step S35 in the case where the flow rate Rin_m is less than or equal to the guaranteed rate Rgur_m. In so doing, when calculating the sum Rextot that appears in Eq. 8, an extra rate is not mistakenly added to the sum for an upstream node whose flow rate Rin_m is less than or equal to the guaranteed rate Rgur_m.

However, as another example, the added rate value for an upstream node whose flow rate Rin_m is less than or equal to the guaranteed rate Rgur_m may also be removed from the formula for calculating the sum Rextot. In this case, the process may be configured to not calculate the data transfer rate Rout′ in step S38 for upstream nodes whose flow rate Rin_m is less than or equal to the guaranteed rate Rgur_m. The process may also be configured to not calculate the pause time PT and the pause interval PI in step S39 for such upstream nodes, and to not transmit a PAUSE frame to such upstream nodes.

In the fifth embodiment described above, the rate margin expressed in Eq. 8 as (Rmax−Rtot) is distributed among the upstream nodes according to the magnitude of the extra rate Rext corresponding to each upstream node. As a result, a flow control is conducted by the communication apparatus 100 such that the data transfer rate to the communication apparatus 100 increases with increasingly larger extra rates Rext. Consequently, data transmission efficiency is improved along the transmission line on the output side of the interface 110 in the communication apparatus 100. Moreover, the transmission efficiency can also be increased along the transmission lines that lead from the flow-controlled communication nodes to the communication apparatus 100.

In the second through the fifth embodiments described above, the guaranteed rates Rgur corresponding to each of the upstream nodes are stored in the communication apparatus 100 or 100a by means of user input operations, for example. In contrast, in the present embodiment, the communication apparatus conducting flow control is configured to be able to acquire guaranteed rates Rgur from upstream nodes via Ethernet. In order to realize such operation in the present embodiment, the Link Layer Discovery Protocol (LLDP) standardized in IEEE 802.1AB is utilized to automatically retrieve the guaranteed rates Rgur.

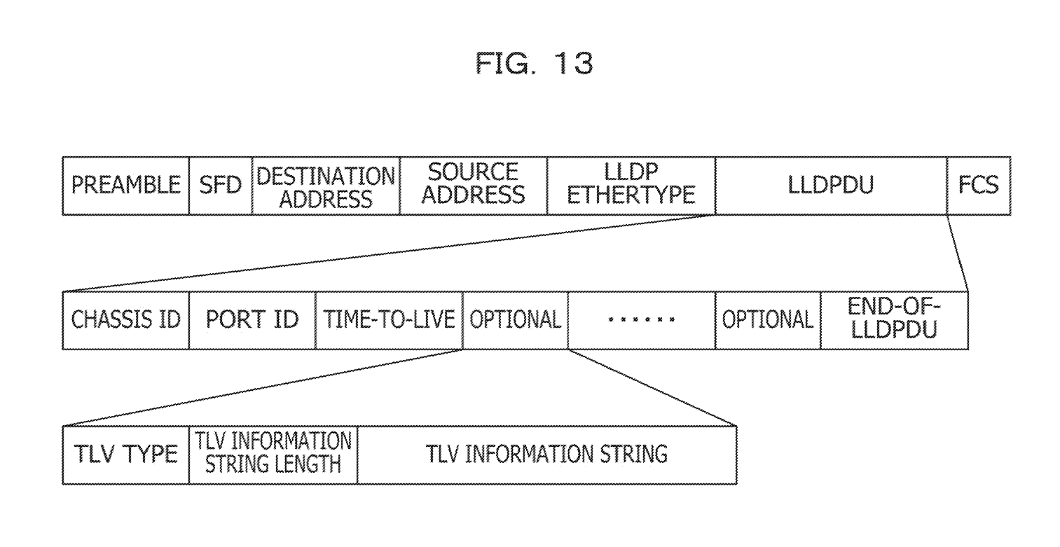

FIG. 13 illustrates the content of an LLDP frame. LLDP is a Layer 2 protocol for advertising information such as the type of network equipment or device and settings information to nearby communication nodes. In LLDP, such information is stored in a MAC frame called an LLDP frame, and then transmitted to other communication nodes.

Similarly to an ordinary MAC frame, an LLDP frame includes a Preamble, an SFD, the destination address, the source address, and an FCS. Additionally, there is also LLDP identification information (LLDP Ethertype) as well as an LLDP Data Unit (LLDPDU), which are both stated between the source address and the FCS. Herein, LLDP frames are transmitted by multicast, and a value indicating multicast is stored in the destination address.

The LLDPDU includes device identification information (Chassis ID), port identification information (Port ID), the period of validity for the information (Time-To-Live), one or more optional elements (Optional), and terminating information (End-of-LLDPDU). These items are stated as TLV (Type, Length, Value) elements, with each item including the information type (TLV type), the value length (TLV information string length), and the value itself (TLV information string).

Also, among the items in the LLDPDU, not only can the predetermined information prescribed in IEEE 802.1AB be stored, but in addition, it is also possible to store arbitrary information in the optional information. Thus, in the present embodiment, the guaranteed rate prescribed for the LLDP frame source node is stored in the optional information area.

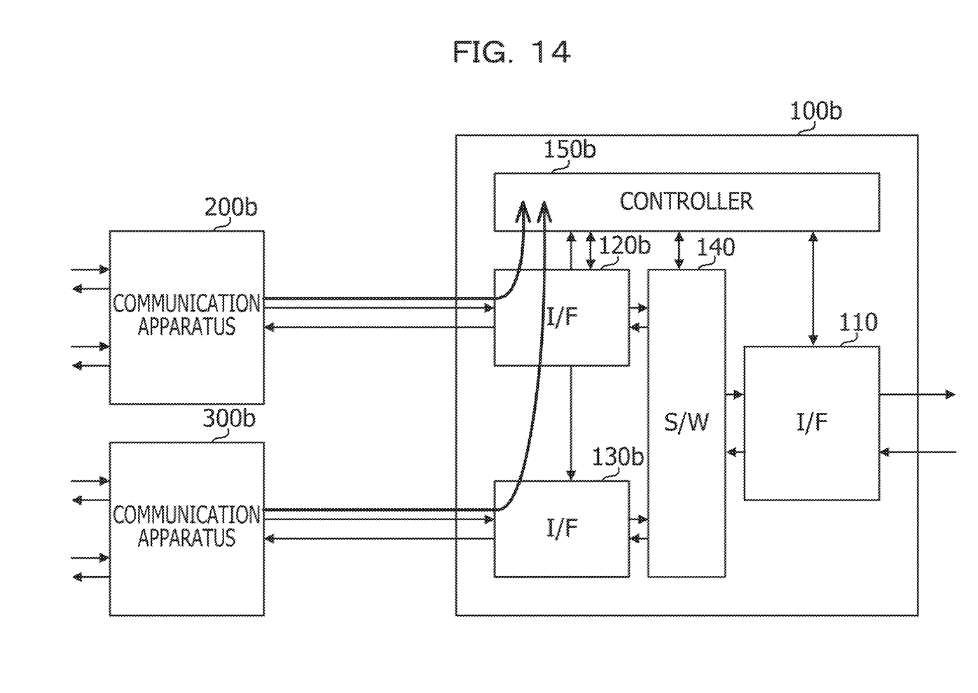

FIG. 14 is a diagram for explaining an LLDP frame delivery process. In FIG. 14, identical reference numbers are used for component elements that are identical to those in FIG. 2.

In FIG. 14, the communication apparatus 100b is connected to communication apparatus 200b and 300b via Ethernet. The communication apparatus 100b includes interfaces 110, 120b, and 130b, a switch 140, and a controller 150b. The interface 120b has a configuration corresponding to that of the interface 120 illustrated in FIG. 3, and sends and receives data to and from the communication apparatus 200b. The interface 130b has a configuration corresponding to that of the interface 130 illustrated in FIG. 3, and sends and receives data to and from the communication apparatus 300b.

The communication apparatus 200b and 300b both periodically transmit LLDP frames by multicast. The communication apparatus 200b stores its prescribed guaranteed rate Rgur in its transmitted LLDP frame, while the communication apparatus 300b stores its prescribed guaranteed rate in its transmitted LLDP frame.

The communication apparatus 100b periodically receives LLDP frames from the communication apparatus 200b and 300b, respectively. The LLDP frame received from the communication apparatus 200b is forwarded from the interface 120b to the controller 150b, while the LLDP frame received from the communication apparatus 300b is forwarded from the interface 130b to the controller 150b.

Although not illustrated in FIG. 14, the communication apparatus 100b may also periodically transmit LLDP frames by multicast.

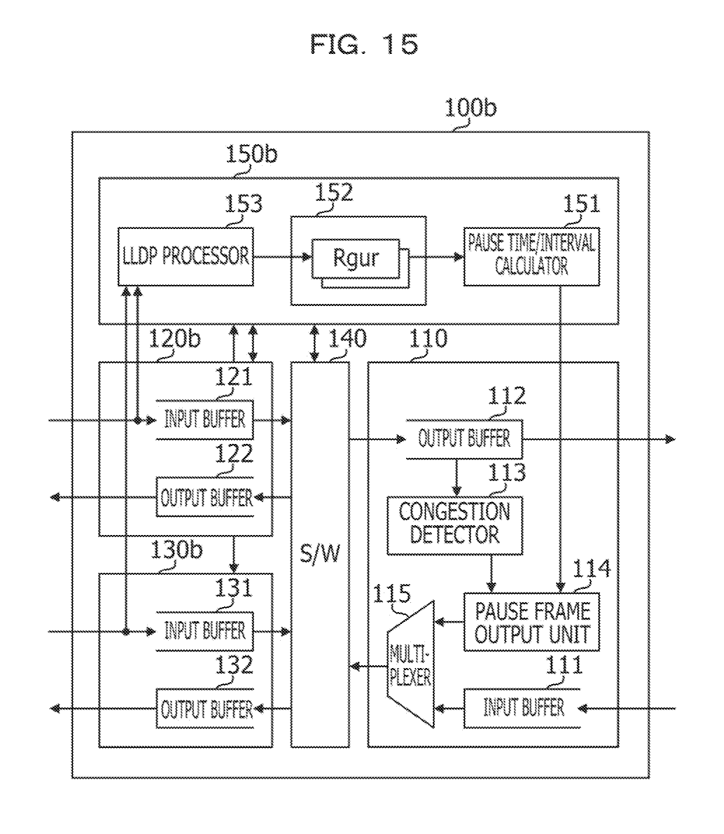

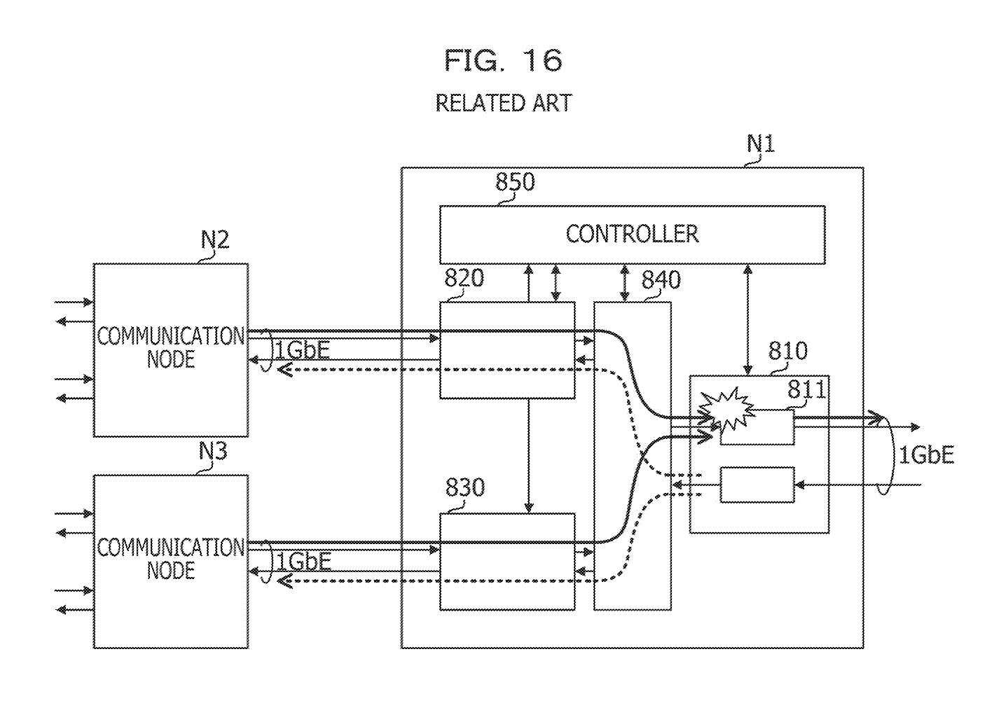

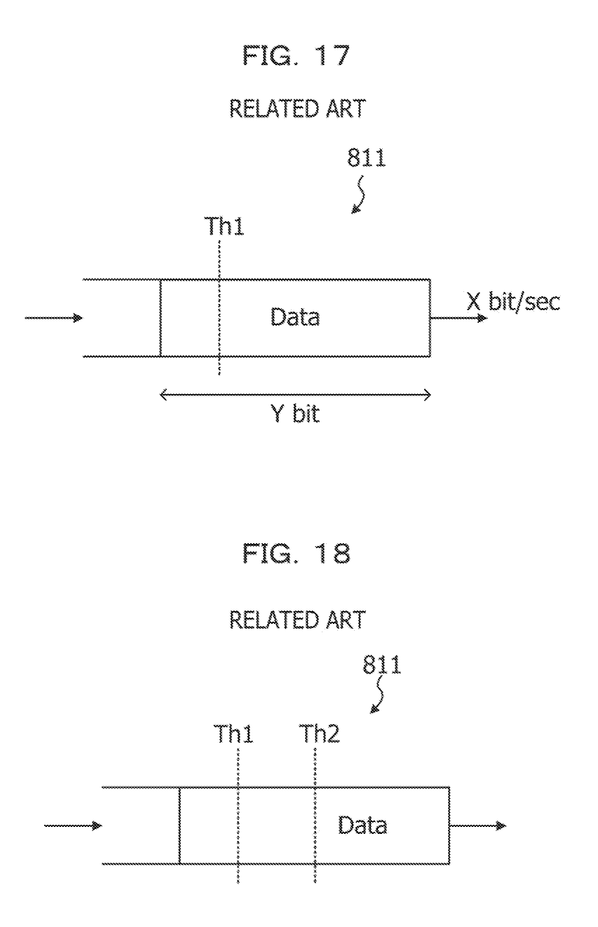

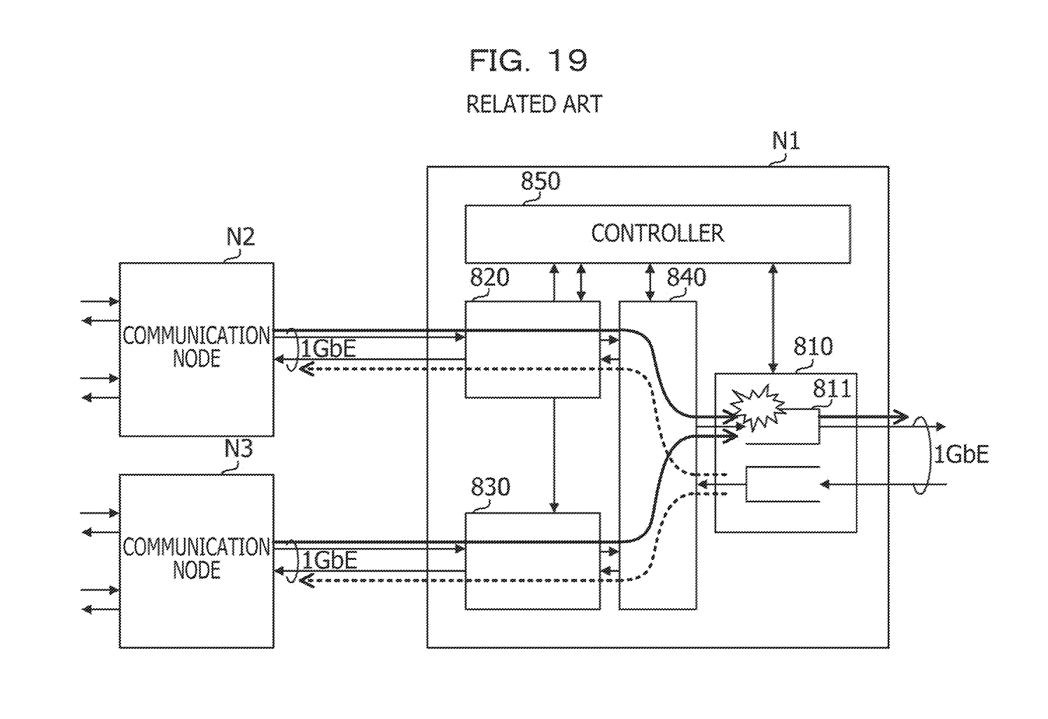

FIG. 15 illustrates the internal configuration of a communication apparatus in accordance with the sixth embodiment. In FIG. 15, identical reference numbers are used for component elements that are identical to those in FIG. 3.

Similarly to the interface 120 illustrated in FIG. 3, the interface 120b includes an input buffer 121 and an output buffer 122. In addition, LLDP frames received from the communication apparatus 200b are forwarded to the controller 150b from the interface 120b. Similarly to the interface 130 illustrated in FIG. 3, the interface 130b includes an input buffer 131 and an output buffer 132. In addition, LLDP frames received from the communication apparatus 300b are forwarded to the controller 150b from the interface 130b.

The controller 150b includes: a pause time/interval calculator 151, which calculates the pause time PT and the pause interval PI used when transmitting a PAUSE frame; and memory 152, which stores guaranteed rates Rgur prescribed for upstream nodes. Additionally, the controller 150b includes an LLDP processor 153, which processes LLDP frames forwarded from the interfaces 120b and 130b.

From a forwarded LLDP frame, the LLDP processor 153 extracts the guaranteed rate Rgur prescribed for an upstream node, and stores the extracted information in the memory 152. In addition, if the guaranteed rate Rgur changes for an upstream node, for example, then the LLDP processor 153 updates the guaranteed rate in the memory 152 on the basis of LLDP frame information received from that upstream node.

The pause time/interval calculator 151 calculates the pause time PT and the pause interval PI for each upstream node, and outputs the results to the PAUSE frame output unit of the interface 110. The pause time/interval calculator 151 performs such calculations by executing a processing sequence in accordance with any of the second through the fourth embodiments described earlier. Alternatively, instead of the pause time/interval calculator 151, the pause time/interval calculator 151a described in the fifth embodiment may also be implemented.

In the sixth embodiment described above, the communication apparatus 100b is able to automatically acquire the guaranteed rates Rgur prescribed for upstream nodes on the basis of LLDP frames, without involving user input. Consequently, an Ethernet provided with flow control functions may be efficiently implemented.

In the second through the sixth embodiments described above, the determination of whether or not to transmit a PAUSE frame is made on the basis of the data size in an output buffer. However, it should be appreciated that the method for determining whether or not to transmit a PAUSE frame is not limited to the above. For example, there exist communication apparatus wherein the input buffers and the output buffers are realized as a single, common buffer, with storage regions inside the common buffer being logically managed on a per-port basis. Such communication apparatus may be configured to transmit a PAUSE frame when the data size in the common buffer becomes equal to or greater than a predetermined threshold value.

In addition, the determination of whether or not to transmit a PAUSE frame may also be made on the basis of the data size in an input buffer rather than an output buffer. In this case, the total data size in the input buffers corresponding to each of a plurality of ports may be monitored. If this total data size becomes equal to or greater than a predetermined threshold value, then PAUSE frames may be transmitted to the upstream nodes connected to those ports.

In addition, in the second through the sixth embodiments described above, a PAUSE frame is transmitted in the case where the data size in a buffer becomes equal to or greater than a predetermined threshold value. However, PAUSE frames may also be transmitted irrespectively of the data size in a buffer. For example, network traffic can be decreased by having the source node continuously transmit PAUSE frames during a period set by the administrator in the PAUSE frame source node.

In addition, the functions included in the communication apparatus described in each of the foregoing embodiments (such as the communication apparatus 100, 100a, and 100b, for example) may also be realized by a computer. In this case, a program stating the processing details of those functions may be provided. By subsequently executing that program on a computer, the above processing functions can be realized on the computer. The program stating the processing details may be stored on a computer-readable recording medium. The computer-readable recording medium may be a magnetic recording apparatus, an optical disc, a magneto-optical recording medium, or semiconductor memory, for example.

In the case of distributing the program, an optical disc or similar portable recording medium storing the program may be sold. Alternatively, the program may be stored in the storage device of a server and transferred to other computers via a network.

The computer that executes the program may, for example, acquire the program from a portable recording medium storing the program or from a server, and then store the program in its own storage device. Subsequently, the computer may read the program from its own storage device, and execute processing in accordance with the program. Herein, the computer may also read the program directly from the portable recording medium and execute processing in accordance with the program. Alternatively, the computer may also successively receive programs from a server, and successively execute processing in accordance with each received program.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Although the embodiment(s) of the present invention(s) has(have) been described in detail, it should be understood that the various changes, substitutions, and alterations could be made hereto without departing from the spirit and scope of the invention.

1. A communication apparatus that sends and receives signals, comprising:
a pause signal transmitter that transmits a pause signal to a plurality of linked apparatuses that send data to the communication apparatus, the pause signal requests that a transmission of data from one of the plurality of link apparatuses to the communication apparatus be temporarily paused; and
a transmission controller that uses guaranteed rates prescribed for respective ones of the plurality of linked apparatuses as a basis for separately controlling how the pause signal is transmitted to each respective one of the plurality of linked apparatuses receiving the pause signal, the transmission controller controls how the pause signal is transmitted such that a data transfer rate from each respective one of the plurality of linked apparatuses to the communication apparatus becomes a rate at least equal to or greater than a guaranteed rate corresponding to the respective linked apparatus.

2. The communication apparatus according to claim 1, further comprising:
a buffer that temporarily stores data sent from the plurality of linked apparatuses; and
a data size detector that detects whether a data size of the data stored in the buffer has reached a predetermined threshold value; and
the pause signal transmitter transmits the pause signal when the data size in the buffer becomes equal to or greater than the threshold value.

3. The communication apparatus according to claim 1, wherein
the transmission controller controls how the pause signal is transmitted such that the data transfer rate from each respective linked apparatus to the communication apparatus becomes equal to the guaranteed rate corresponding to the respective linked apparatus.

4. The communication apparatus according to claim 1, wherein
the transmission controller controls how the pause signal is transmitted such that the data transfer rate from each respective linked apparatus to the communication apparatus becomes a rate equal to the guaranteed rate corresponding to the respective linked apparatus, plus an added rate value, and
the added rate value is a value obtained by summing the guaranteed rates corresponding to all of the plurality of linked apparatuses to generate a sum, subtracting the sum from a predetermined maximum rate to generate a subtracted value, and dividing the subtracted value by the number of linked apparatus.

5. The communication apparatus according to claim 4, further comprising:
a forwarding controller that forwards data sent from the each respective linked apparatus to another one of the plurality of linked apparatuses that is different from the each respective linked apparatus;
the predetermined maximum rate is the maximum data transfer rate from the communication apparatus to the another one linked apparatus.

6. The communication apparatus according to claim 1, wherein
the transmission controller controls how the pause signal is transmitted such that the data transfer rate from each respective linked apparatus to the communication apparatus becomes equal to the guaranteed rate corresponding to the respective linked apparatus, plus an added rate value that is determined individually for each linked apparatus, and
the added rate value corresponding to each respective linked apparatus is the value obtained by summing the guaranteed rates corresponding to all of the plurality of linked apparatuses to generate a sum, subtracting the sum from a predetermined maximum rate to generate subtract value, and multiplying the subtracted value by a ratio of the guaranteed rate for the each respective linked apparatus with respect to the sum.

7. The communication apparatus according to claim 6, further comprising:
a forwarding controller that forwards data sent from the each respective linked apparatus to another one of the plurality of linked apparatuses that is different from the each respective linked apparatus;
the predetermined maximum rate is the maximum data transfer rate from the communication apparatus to the another one linked apparatus.

8. The communication apparatus according to claim 7, further comprising:
a rate measuring unit that measures respective data input rates from the plurality of linked apparatuses to the communication apparatus; and
the transmission controller recognizes which of the plurality of linked apparatuses are surplus-rate linked apparatuses for each of which the measured value of the data input rate is greater than the guaranteed rate, and then controls how the pause signal is transmitted to the surplus-rate linked apparatuses such that the data transfer rate from each respective surplus-rate linked apparatus to the communication apparatus becomes a rate equal to the guaranteed rate corresponding to the each respective surplus-rate linked apparatus, plus an added rate value that is determined individually for each respective surplus-rate linked apparatus, and
the added rate value corresponding to each respective surplus-rate linked apparatus is a value obtained by
computing a first subtracted value by subtracting the measured value for the data input rate from each respective surplus-rate linked apparatus from the guaranteed rate corresponding to the each respective surplus-rate linked apparatus,
computing a first sum by summing the first subtracted values corresponding to all surplus-rate linked apparatuses,
dividing the first subtracted value for each respective surplus-rate linked apparatus by the first sum,
computing a second sum by summing the guaranteed rates for all linked apparatus,
computing a second subtracted value by subtracting the second sum from a predetermined maximum rate, and
multiplying the quotient from the above division by the second subtracted value.

9. The communication apparatus according to claim 8, further comprising:
a forwarding controller that forwards data sent from the each respective linked apparatus to another one of the plurality of linked apparatuses that is different from the each respective linked apparatus;
wherein
the predetermined maximum rate is the maximum data transfer rate from the communication apparatus to the another one linked apparatus.

10. The communication apparatus according to claim 1, wherein
the transmission controller specifies to the pause signal transmitter,
pause time information, which indicates an amount of time for which each respective linked apparatus is made to pause the transmission of data to the communication apparatus, and
pause interval information, which indicates an interval at which each respective linked apparatus is to start pausing the transmission of data to the communication apparatus,
and
the pause signal transmitter transmits the pause signal on the basis of the pause time information and the pause interval information specified for each respective linked apparatus.

11. The communication apparatus according to claim 10, wherein
the pause signal contains a time information region, into which is inserted information indicating an amount of time during which a recipient linked apparatus that receives the pause signal is made to pause the transmission of data, and
the pause signal transmitter transmits the pause signal with the pause time information inserted into the time information region, and at the interval indicated by the pause interval information.

12. The communication apparatus according to claim 10, wherein
the pause signal contains a time information region, into which is inserted the amount of time during which the recipient linked apparatus is made to pause the transmission of data,
the pause signal transmitter transmits a first pause signal with an amount of time inserted into the time information region that is significantly larger than the amount of time indicated by the pause time information,
after the amount of time indicated by the pause time information has elapsed, the pause signal transmitter transmits a second pause signal with 0 inserted into the time information region, and
the pause signal transmitter respectively transmits the first pause signal and the second pause signal at the interval indicated by the pause interval information.

13. The communication apparatus according to claim 1, further comprising:
a guaranteed rate extractor that extracts the guaranteed rate prescribed for each respective linked apparatus from data sent by the each respective linked apparatus.

14. The communication apparatus according to claim 1, further comprising:
a forwarding controller that forwards data sent from each respective linked apparatus to another one of the plurality of linked apparatuses that is different from the each respective linked apparatus;
an outgoing buffer that temporarily stores data that has been sent from the each respective linked apparatus, and which will be forwarded to the another one linked apparatus by the forwarding controller; and
a data size detector that detects whether a data size of the data stored in the outgoing buffer has reached a predetermined threshold value;
wherein
the pause signal transmitter transmits the pause signal when the data size in the outgoing buffer becomes equal to or greater than the threshold value.

15. A communication control method for a communication apparatus that sends and receives signals, the method comprising:
on the basis of guaranteed rates prescribed for each of a plurality of linked apparatus that send data to the communication apparatus, outputting control information corresponding to each respective linked apparatus such that a data transfer rate from each respective linked apparatus to the communication apparatus become a rate equal to or greater than a guaranteed rate corresponding to the each respective linked apparatus; and
on the basis of the control information, transmitting to the each respective linked apparatus a pause signal requesting that the transmission of data to the communication apparatus be temporarily paused.
